(19) United States
(12) Patent Application Publication
(10) Pub. No.: US 2010/0312598 A1
(43) Pub. Date: Dec. 9, 2010

(54) COST SAVINGS IN A PRINT QUEUE CONTROL SYSTEM

(75) Inventors: Karsten Huster, Lienen (DE); Axel Behrens, Zeven (DE)

Correspondence Address: CANON U.S.A. INC. INTELLECTUAL PROPERTY DIVISION, 15975 ALTON PARKWAY, IRVINE, CA, 92618-3731, US

(73) Assignee: Canon Europa N.V.

(21) Appl. No.: 12/478,122

(22) Filed: Jun. 4, 2009

(51) Int. Cl. G06Q 10/00; G06F 3/12; G06Q 50/00

(52) U.S. Cl. 705/8; 358/1.15; 705/30

(57) ABSTRACT

A method of recording cost savings performed by a print queue control system includes calculating a cost associated with performing an original print job provided by a device in communication with the print queue control system, and calculating a cost associated with performing an altered print job derived from the original print job. The method further includes, in response to the altered print job being performed instead of the original print job, storing details of a cost saving associated with performing the altered print job instead of the original print job.

### BACKGROUND OF THE INVENTION

1. Field of the Invention

The present invention generally relates to a method of recording cost savings in a print queue control system, and a print queue control system therefor.

2. Description of the Related Art

A known network printing system is shown in FIG. 1. The system comprises a local area network 1. Connected to the network are personal computers 2 and 3, a print server 4, and printers 5 and 6.

When a user prints a document from, for example, personal computer 3, the print job corresponding to the document is sent to the print server 4, where it is stored in a print queue. The print job may be stored securely in the print queue using the credentials with which the user logged on to the personal computer 3, e.g., their network username and password.

The user can then go to a printing device connected to the network 1, such as the printer 5. The printing device may be a dedicated printer, or may for example be a multi-function device such as a combined photocopier, scanner and printer (an “MFP”). The printer 5 comprises an input panel and a screen (not shown), with which the user can log on to the printer 5, using the same credentials as above. The printer 5 then retrieves from the print server 4 a list of the print jobs stored in its print queue that belong to the user. For example, the relevant print jobs may be identified as being stored using the user's logon credentials. The list of print jobs may then be displayed on the screen of the printer 5. Alternatively, a user may log on to the printer 5 using a different set of credentials, such as those provided by a security access card. In that case, the fact that the different credentials are associated with the same user can be recorded in a database on the print server 4, thus allowing the relevant print jobs to be identified.

Using the screen and input panel, the user can select a print job from the list and have that document printed by the printer. The user can also select a print job and have that print job deleted from the print queue on the print server 4, without the document being printed. A user might delete the print job if it had been created in error, for example if it comprised a document selected in error or with the wrong print options.

Another feature of the network printing system of FIG. 1 may be “rule-based routing”, which is as follows. As before, when a user prints a document from personal computer 3, the print job corresponding to the document is sent to the print server 4. In this case, however, the print server 4 selects the printing device on which the print job is to be performed, using a set of rules stored in the print server 4. These rules can be configured by an administrator of the system, and can be used to ensure that print jobs are performed upon a suitable printing device. For example, printer 5 may be able to print quickly and cheaply, but unable to print in colour or in high quality. Conversely, printer 6 may be able to produce a high-quality colour output, but may be slow and expensive to run. An example rule may then be that all emails and documents above a certain size are printed upon printer 5, but all graphics files are printed upon printer 6, thus ensuring that a suitable, and even the most appropriate printer, is used in each case.

An extension of the rule-based routing feature is “interactive rule-based routing”. In this case, when the print server 4 receives a print job from, for example, the personal computer 3, it sends a message back to the personal computer 3, giving options for performing the print job. The personal computer 3 would then display the message, allowing the user of the personal computer 3 to decide how to perform the print job. For example, the message might indicate that, as the document contained in the print job is very large, it should be printed on the printer 5. The user can then instruct the print server 4 to send the print job to the appropriate printing device. For example, the user may be happy for the print job to be performed on the printer 5. On the other hand, the user may prefer the print job to be performed on the printer 6 even though it is very large; this might be the case if the document contained in the print job is an official report, for example.

It is an advantage of the known network printing system of FIG. 1 that it is able to provide cost savings compared to other conventional printing systems. In the known network printing system of FIG. 1, unwanted print jobs can be deleted before they are performed, whereas in other conventional printing system print jobs may be performed immediately, and it may thus be difficult and often even impossible to prevent printing from happening even after it has been realized that the print job was created in error. Further the rule-based routing and interactive rule-based routing may help ensure that print jobs are performed on a suitable and even the most appropriate printer, which can also provide cost savings.

However, known network printing systems do not provide any indication of the cost savings that may be achieved with such systems.

### SUMMARY OF THE INVENTION

In accordance with a first aspect of the present invention, there is provided a method of recording cost savings in a print queue control system including calculating a cost associated with performing an original print job provided by a device in communication with the print queue control system, calculating a cost associated with performing an altered print job derived from the original print job, and in response to the altered print job being performed instead of the original print job, storing details of a cost saving associated with performing the altered print job instead of the original print job.

In accordance with a second aspect of the present invention, there is provided a print queue control system including a print queue for storing print jobs provided by devices in communication with the print queue control system, a cost calculator arranged to calculate a cost associated with performing a print job, and a savings data store for storing cost savings data. The print queue control system is configured, in response to an original print job being provided by a device in communication with the print queue control system, to calculate using the cost calculator a cost associated with performing the original print job and a cost associated with performing an altered print job derived from the original print job. The print queue control system is further configured, in response to the altered print job being performed instead of the original print job, to store details of a cost saving associated with performing the altered print job instead of the original print job in the savings data store.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain principles of the present invention.

FIG. 1 shows a known network printing system.

FIG. 2 shows an example of a print server according to an embodiment of the present invention.

FIG. 3 is an example of a table of rules for rule-based routing.

FIG. 4 is an example of a table of cost calculation data.

FIG. 5 is a flow chart showing an example of a first use of the present invention.

FIG. 6 is a flow chart showing an example of a second use of the present invention.

FIG. 7 is an example of a message to be displayed on a personal computer.

### DESCRIPTION OF THE EMBODIMENTS

Various exemplary embodiments, features, and aspects of the present invention will now be herein described in detail below with reference to the drawings. It is to be noted that the relative arrangement of the components set forth in these embodiments is not intended to limit the scope of the present invention.

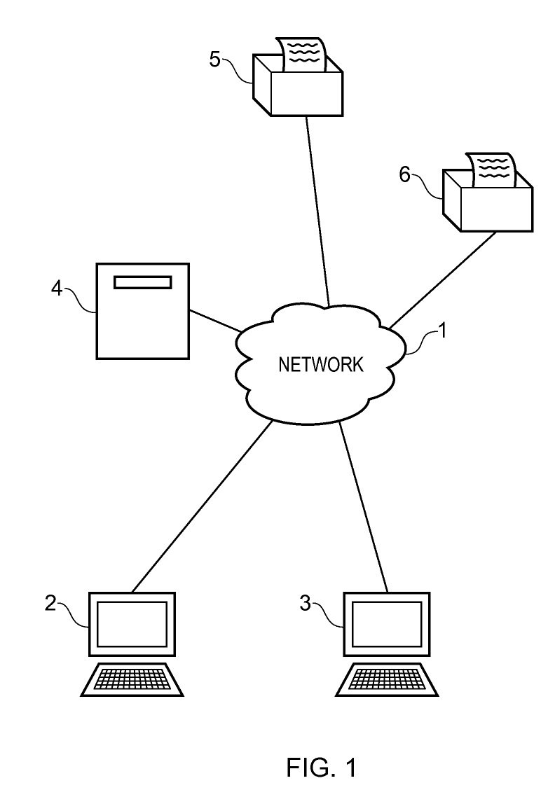

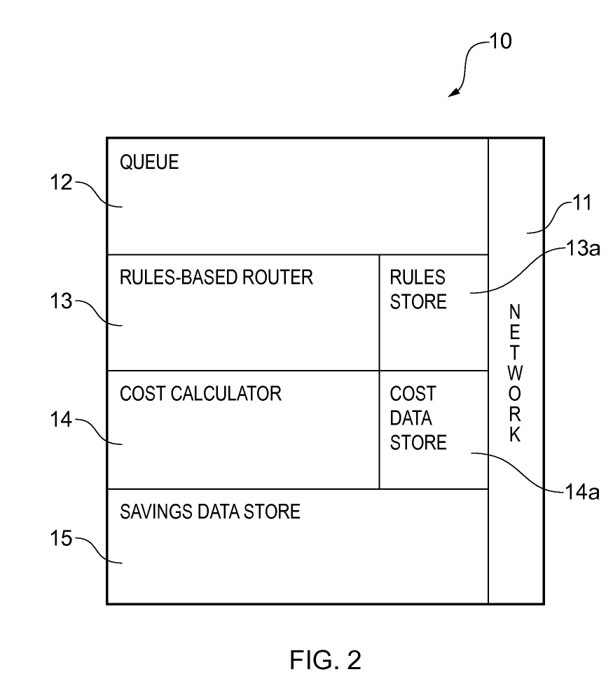

A print server 10 in accordance with an embodiment of the present invention is shown in FIG. 2. The print server 10 may be used in a network printing system such as that shown in FIG. 1, for example with the print server 10 of FIG. 2 replacing the known print server 4 of FIG. 1, as described below.

In the embodiment as shown, the print server 10 has a network interface 11, for communication over the network 1 with devices such as for example the personal computers 2 and 3 and printers 5 and 6. The print server 10 comprises a print queue 12 for storing print jobs provided by devices such as, e.g., the personal computers 5 and 6. The print jobs stored in the print queue 12 of the print server 10 may be sent to, e.g., the printers 5 and 6 for printing.

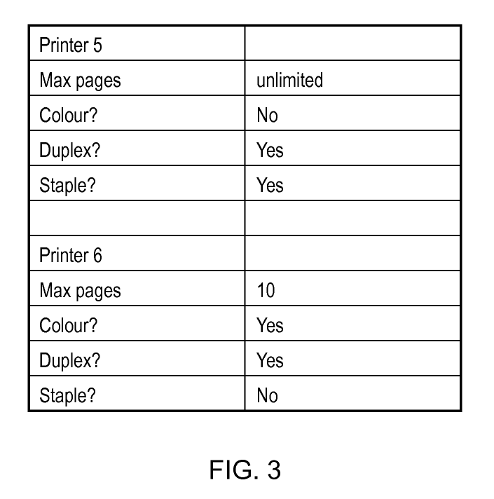

The print server 10 in the embodiment as shown has a rule-based router 13 with a rules store 13a (i.e., a rules storage unit). Example rules for printers 5 and 6 are shown in FIG. 3, where various attributes for the printers are given (e.g., ability to print in colour, duplex, stapling, and maximum number of pages). The rules-based router 13 may be used to provide rule-based routing and/or interactive rule-based routing, such as that described above. When a print job is sent to the print server 4 for performance on a particular printer, the attributes (e.g., colour/black and white, single-sided/duplex, stapling, number of pages) of the print job may be compared to the attributes stored in the rules store 13a for that printer.

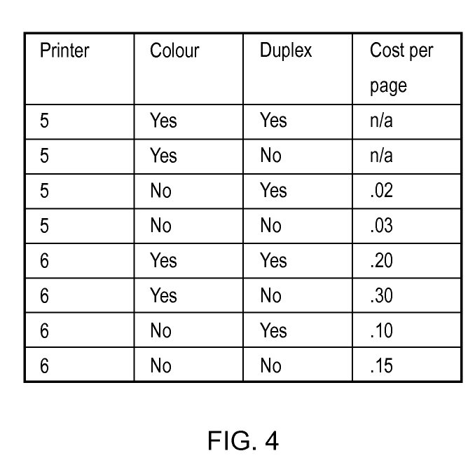

The print server 10 in the embodiment as shown also has a cost calculator 14 with a cost data store 14a (i.e., cost data storage unit). Example cost data and/or cost data rules are shown in FIG. 4, where a cost per page for printing on the printers 5 and 6 according to different rules (e.g. colour printing, duplex printing) is given. The cost data may be used by the cost calculator to calculate a cost associated with a print job. The print server 10 according to the embodiment also has a savings data store 15 (i.e., savings data storage unit) for storing cost savings data.

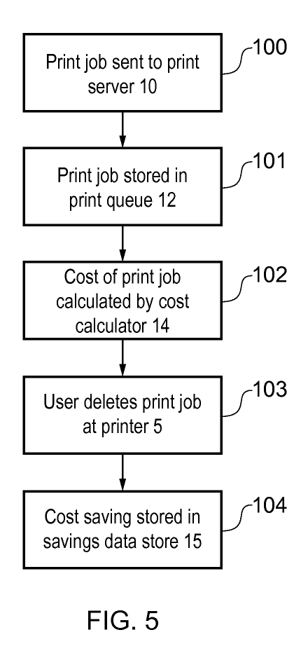

FIG. 5 is a flow chart showing an example of a first process according to the present embodiment of the invention. First, in step S100, a user sends a print job to the print server 10, for example from the personal computer 2. In step S101, the print job is stored in the print queue 12. The cost calculator 14 then calculates the cost of performing the print job in step S102. According to this example, at the printer 5, the user decides that they do not wish to complete the print job, and deletes it in step S103. In response to the print job being deleted, the details of the cost saving (e.g., the cost of the print job if it had been performed) are stored in the savings data store 15 in step S104.

Alternatively, the cost of a print job may be calculated (step S102) only after a print job has been deleted (step S103).

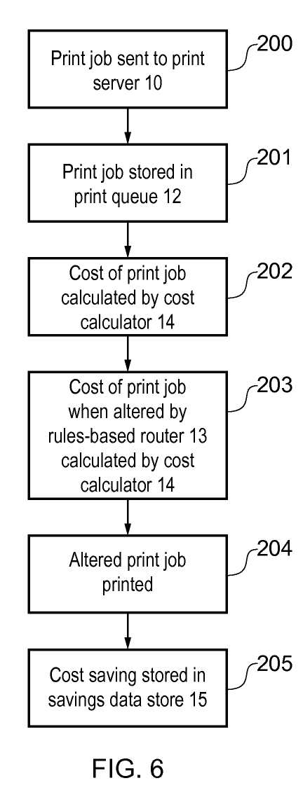

FIG. 6 is a flow chart showing an example of a second process according to the present embodiment of the invention. As before, a user first sends a print job to the print server 10 from the personal computer 2 in step s200, the print job is stored in the print queue 12 in step S201, and the cost of performing the print job is calculated in step S202.

Next, according to this example, the attributes of the print job may be compared with the rules in the rules store 13a for the printer on which the print job is to be performed. If one or more of the conditions is violated (for example a print job including a document of 100 pages is sent to printer 6, in a case where it is set to print a maximum of 10 pages), a suitable printer for the print job may be derived (i.e., pre-determined) according to the rules in the rules store 13a. For example, a print job including a document of 100 pages could be performed on printer 5, in a case where it has no page limit. The cost of the print job when altered to use the new printer is then calculated by the cost calculator 14 in step S203.

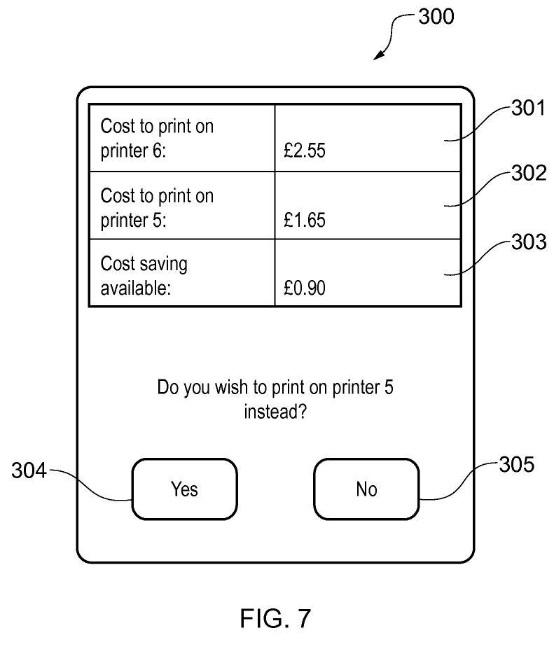

The altered print job may then be performed in step S204. This may happen automatically (for example, as a result of rule-based routing). Alternatively, details of the cost saving associated with performing the altered print job instead of the original print job may be sent to the personal computer 2, and a message 300, such as for example that shown in FIG. 7, may be displayed to the user. The message 300 as shown in the example of FIG. 7 shows the cost of the original print job (field 301), the altered print job (field 302), and the cost saving that can be obtained when the altered print job is selected (field 303) instead of the original print job. The user can then select whether the original or altered print job is to be performed using the buttons 304 and 305. Alternatively, the cost saving for each possible printer may be calculated, and a message may be displayed to the user to allow them to select the printer they wish to use from amongst the entire set of possible printers.

In each case, when/if the altered print job is performed, details of the cost saving are stored in the savings data store 15 in step S205.

The cost saving data stored in the savings data store may be, for example, accessed by an administrator and used as desired, such as to produce reports showing the cost savings provided by the system. In one version, the cost saving data stored may be only the pure cost saving (i.e., the difference between the costs calculated for the original print job and the altered print job). Alternatively, in another version, more detailed information may be stored, such as the costs calculated for the original print job and the altered print job themselves. Details of the printer associated with the cost savings may also be stored. For example, a printer on which cost savings are obtained by choosing duplex printing instead of single-side printing may be identified. In that case, a running total of cost savings can be sent to the printers for display on their screens.

In a further embodiment of the present invention, there is provided a method of recording cost savings in a print queue control system, the method comprising calculating a cost associated with performing an original print job provided by a device in communication with the print queue control system, calculating a cost associated with performing an altered print job derived from the original print job, and in response to the altered print job being performed instead of the original print job, storing details of a cost saving associated with performing the altered print job instead of the original print job.

Using this method, the cost savings associated with altering print jobs, such as for example by using the features of the print queue control system (which print queue control system may correspond to, for example, the print server 10), can be recorded. Any costs associated with the print jobs may be used, including for example at least one of the cost of the paper on which the document associated with the print job is to be printed, the cost of the ink used for printing, maintenance costs for the printer used, and so on. The costs may be those of the direct users of the printer queue control system, and/or may for example be costs for customers or similar persons. Any level of detail of the cost saving may also be recorded, such as for example the resulting cost saving only, or full details of the original and altered print jobs and their respective costs.

In one version, the altered print job may be the deletion of the original print job. This allows recording of the cost saving associated with preventing unwanted print jobs from being performed. In another version, the altered print job may be derived from the original print job using, for example, a pre-defined set of rules stored in the print queue control system. This allows the cost saving associated with one or more of rule-based routing and interactive rule-based routing to be recorded.

According to one embodiment, the print queue control system sends details of the cost saving associated with the altered print job being performed instead of the original print job to the device which provided the original print job (e.g., computer 2 or 3), prior to performing of either the altered or original print job, to allow a user of the device to decide whether to select the altered print job instead of the original print job. This allows the user to take the potential cost saving into account when deciding whether to alter the print job, for example when using interactive rule-based routing.

The method further may further include sending the details of the cost saving associated with altered print job being performed instead of original print job to the printer for which the cost saving was made, for display by the printer. This may provide a more convenient method for indicating the cost savings resulting from using a particular printer.

In a further embodiment of the present invention, there is provided a print queue control system comprising a print queue for storing print jobs provided by devices in communication with the print queue control system, a cost calculator arranged to calculate a cost associated with performing a print job, and a savings data store for storing cost savings data. According to this embodiment, the print queue control system may be configured, in response to an original print job being provided by a device in communication with the print queue control system, to calculate using the cost calculator a cost associated with performing the original print job and a cost associated with performing an altered print job derived from the original print job. The print queue control system may further be configured, in response to the altered print job being performed instead of the original print job, to store details of the cost saving associated with performing the altered print job instead of the original print job in the savings data store.

In one version, the print queue control system is the print server.

In another version, the print queue control system further comprises a rules-based router comprising a store of pre-defined rules, wherein the rules-based router is configured to derive the altered print job from the original print job using the pre-defined rules stored in the print queue control system.

In yet another version, the print queue control system is further arranged to send details of the cost saving associated with performing the altered print job instead of the original print job to the device which provided the original print job, prior to performing either the altered or original print job, to allow a user of the device to decide whether to print the altered print job instead of the original print job.

The print queue control system may be further arranged to send details stored in the savings data store to the printer for which the cost saving was made, for display by the printer.

In one version, a computer-readable storage medium is provided having computer-executable instructions stored thereon for causing the print queue control system to perform a method of recording cost savings according to any of those described above.

Aspects of the present invention can include supplying a computer-readable recording medium including a program and/or computer-executable instructions that operate one or more of the configurations described above so as to realize functions according to the above embodiments, to a computer or other device, such as the print queue control system, that reads out and executes the program code and/or computer-executable instructions stored in the recording medium. The computer or other device (e.g., CPU or MPU of such computer or other device) in the system or the apparatus reads the program code and/or computer-executable instructions stored in the storage medium. In this case, aspects of the present invention may include the recording medium storing the program and/or computer-executable instructions itself.

The recording medium may be, for example, at least one of a flexible disk, a hard disk, an optical disk, a magneto-optical disk, a compact disk-read only memory (CD-ROM), a magnetic tape, a nonvolatile memory card, and a read only memory (ROM). The program code and/or computer-executable instructions can also be downloaded via a network.

According to aspects of the present invention, the program and/or computer-executable instructions recorded on the recording medium may perform processing by itself, as well as with the operating system (OS) in cooperation with another software or expansion board to perform functions according to the above exemplary embodiments.

In addition, aspects of the present invention can involve a case where the functions according to the above-described exemplary embodiments may be implemented as follows. The program code and/or computer-executable instructions read out from the storage medium are written in a memory which is provided in a function extension board inserted in a computer or other device, or in a function extension unit connected to the computer and/or device. Thereafter, a part or the whole of the actual processing may be executed by a CPU or the like, which is incorporated in the function extension board or the function extension unit, in accordance with instructions from the program code and/or computer-executable instructions.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

What is claimed is:

1. A method of recording cost savings performed by a print queue control system, the method comprising:
calculating a cost associated with performing an original print job provided by a device in communication with the print queue control system;
calculating a cost associated with performing an altered print job derived from the original print job;
in response to the altered print job being performed instead of the original print job, storing details of a cost saving associated with performing the altered print job instead of the original print job.

2. The method according to claim 1, wherein the altered print job is the deletion of the original print job.

3. The method according to claim 1, wherein the altered print job is derived from the original print job using a pre-defined set of rules stored in the print queue control system.

4. The method according to claim 1, wherein the print queue control system sends details of the cost saving associated with performing the altered print job instead of the original print job to the device which provided the original print job, prior to printing, to allow a user of the device to decide whether to perform the altered print job instead of the original print job.

5. A method according to claim 1, further comprising:
sending the details of the cost saving associated with performing the altered print job instead of the original print job to a printer for which the cost saving was made, for display by the printer.

6. A print queue control system comprising:
a print queue for storing print jobs provided by devices in communication with the print queue control system;
a cost calculator arranged to calculate a cost associated with performing a print job; and
a savings data store for storing cost savings data;
wherein the print queue control system is configured, in response to an original print job being provided by a device in communication with the print queue control system, to calculate using the cost calculator a cost associated with performing the original print job and a cost associated with performing an altered print job derived from the original print job, and is further configured, in response to the altered print job being performed instead of the original print job, to store details of a cost saving associated with performing the altered print job instead of the original print job in the savings data store.

7. The print queue control system according to claim 6, further comprising a rules-based router comprising a store of pre-defined rules, wherein the rules-based router is configured to derive the altered print job from the original print job using the pre-defined rules.

8. The print queue control system according to claim 6, wherein the print queue control system is further configured to send details of the cost saving associated with performing the altered print job instead of the original print job to the device which provided the original print job, prior to printing, to allow a user of the device to decide whether to print the altered print job instead of the original print job.

9. The print queue control system according to claim 6, wherein the print queue control system is further configured to send details stored in the savings data store to a printer for which the cost saving was made, for display by the printer.

10. A computer-readable storage medium having computer-executable instructions stored thereon for causing a print queue control system to perform a method of recording cost savings, the computer-readable storage medium comprising:
computer-executable instructions for calculating a cost associated with performing an original print job provided by a device in communication with the print queue control system;
computer-executable instructions for calculating a cost associated with performing an altered print job derived from the original print job; and
computer-executable instructions for, in response to the altered print job being performed instead of the original print job, storing details of a cost saving associated with performing the altered print job instead of the original print job.

11. A computer-readable storage medium having computer-executable instructions stored thereon for causing a print queue control system to perform a method of recording cost savings, the computer-readable storage medium comprising:
computer-executable instructions for storing print jobs provided by devices in communication with the print queue control system;
computer-executable instructions for calculating a cost associated with performing a print job; and
computer-executable instructions for storing cost savings data;
wherein, in response to an original print job being provided by a device in communication with the print queue control system, a cost associated with performing the original print job and a cost associated with performing an altered print job derived from the original print job are calculated, and wherein, in response to the altered print job being performed instead of the original print job, details of a cost saving associated with performing the altered print job instead of the original print job are stored.

12. A method of recording cost savings performed by a print queue control system, the method comprising:
calculating a cost associated with performing an original print job provided by a device in communication with the print queue control system;
in response to the print job being deleted before performance of the print job, storing details of a cost saving associated with deleting the print job.

13. A print queue control system comprising:
a print queue for storing print jobs provided by devices in communication with the print queue control system;
a cost calculator arranged to calculate a cost associated with performing a print job; and
a savings data store for storing cost savings data;
wherein the print queue control system is configured, in response to a print job being provided by a device in communication with the print queue control system, to calculate using the cost calculator a cost associated with performing the print job, and is further configured, in response to the print job being deleted before performance of the print job, to store details of a cost saving associated with deleting the print job in the savings data store.

14. A computer-readable storage medium having computer-executable instructions stored thereon for causing a print queue control system to perform a method of recording cost savings, the computer-readable storage medium comprising:
computer-executable instructions for storing print jobs provided by devices in communication with the print queue control system;
computer-executable instructions for calculating a cost associated with performing a print job; and
computer-executable instructions for storing cost savings data;
wherein, in response to a print job being provided by a device in communication with the print queue control system, a cost associated with performing the print job is calculated, and wherein, in response to the print job being deleted before the print job is performed, details of a cost saving associated with deleting the print job are stored.
